(19) United States
(12) Patent Application Publication
(10) Pub. No.: US 2004/0254309 A1
(43) Pub. Date: Dec. 16, 2004

(54) Use of cumulative distributions to improve reactor control

(76) Inventors: John R. Parrish, Cross Lanes, WV (US); William H. Sachs, Princeton, NJ (US); Mark L. Nelson, Charleston, WV (US)

Correspondence Address: JENKENS & GILCHRIST, 1401 MCKINNEY, SUITE 2600, HOUSTON, TX, 77010, US

(21) Appl. No.: 10/845,969

(22) Filed: May 14, 2004

Related U.S. Application Data
(60) Provisional application No. 60/471,269, filed on May 16, 2003.

(51) Int. Cl. C08F 2/00

(52) U.S. Cl. 526/59; 526/113; 526/65

(57) ABSTRACT

A method of manufacturing a polymer composition that includes initiating a polymerization reaction at an initial set of polymerization parameters, determining a distribution of the at least one property of an intermediate polymer composition, and adjusting the initial set of polymerization parameters based on the distribution of the at least one property to obtain a desired distribution of the at least one property in the polymer composition. The method is suitable for use in blending and trimming operations as well as in polymerization processes.

This application claims priority to prior filed U.S. Provisional Patent Application Ser. No. 60/471,269, filed on May 16, 2003, which is incorporated by reference herein in its entirety.

### FEDERALLY SPONSORED RESEARCH

Not Applicable.

### REFERENCE TO MICROFICHE APPENDIX

Not Applicable.

1. Field of the Invention

This invention relates to the manufacture of polyolefin resins, and in particular to the manufacture of polyolefin resins having polymodal, especially bimodal, molecular weight, density, or other characteristics.

2. Background of the Invention

Multi-modal, multivariative molecular weight and chemical composition distributions have become increasingly important product design features for high performance polyolefin resins. Mixed-catalyst systems represent a major advance in meeting the requirements for such polyolefin resins, in part because mixed catalyst systems have lower capital investment costs. But product consistency and reactor performance could be improved in these systems.

Bimodal resins were made in two separate reactors or reaction chambers. In the case of bimodal molecular weight distribution products, a product having a first molecular weight was moved directly from the reaction zone in which it was made and introduced to a reaction zone having conditions for making a resin of a different molecular weight, where more resin was made. The two resins are thus mixed or, in some cases, even present in the same particles. Two-stage processes are naturally more complex to control and are more expensive to construct because two reactors, or at least two reaction zones, are required to build and precisely control. In addition, because the products are made in separate reactors, the resulting composition may not be homogeneously mixed, in that at least some particles will consist of the product of one reactor or the other. It is therefore desirable to find ways of making homogeneous bimodal polyolefins in a single reactor, as well as better controlling resin made in multi-reactor systems.

One approach to making bimodal polyolefins in a single reactor has been to employ a mixed catalyst system, in which one catalyst component makes a primarily low molecular weight (LMW) product, and the other catalyst component produces a primarily high molecular weight (HMW) product. By including both of these catalyst components in the same catalyst composition, a bimodal product may be produced. In a system using mixed catalysts, the LMW product and HMW product may be intimately mixed. The result is a resin that is relatively free of gels compared to similar products made in staged-reactor processes or by the blending of two distinct unimodal resins. In addition, producing bimodal products in a single reactor relieves the necessity of a separate blending step, and allows them to be produced more quickly and efficiently.

Mixed catalyst systems also allow the composition of the polymer product to be tailored in other ways. One way to tailor the composition is to select catalysts with certain comonomer incorporation kinetics. For example, a catalyst for making the LMW component having favorable comonomer incorporation kinetics can be selected where the desired product has a LMW component having high comonomer content is desired. Likewise, where a blend having a HMW component with high comonomer content is desired, a HMW catalyst that is capable of incorporating comonomer can be selected. In this way, a mixed catalyst system that uses two catalysts having relatively the same or different comonomer incorporation efficiencies can be used to tailor the density of each component of the bimodal composition.

Controlling the ratio of the components (also called “split”) in the bimodal product is also a significant manufacturing concern. Product properties of bimodal resins are often extremely sensitive to component split. For instance, in the manufacture of certain products it is necessary to control the component split to within about 1-2% of the target set point in order for the composition to have the desired properties.

The split, usually measured as the weight percentage of a component, in the total product components of a bimodal resin made in a single-reactor is primarily a function of the relative amount and activity of each of the catalysts in the catalyst system. Theoretically, a catalyst system containing proper amounts of each catalyst could be generated and used to produce the desired split for a particular end composition. But in practice such systems are difficult to control because the relative productivities of the catalyst components change over the course of the polymerization process. For instance, each of the catalysts in a mixed catalyst system typically has a different sensitivity to variations in reactor conditions or poison levels. Small fluctuations in the relative feed rates of each catalyst can also affect the split of the resulting composition.

For product control considerations, the overall distribution of a property of a polymer composition varies in response to changes in the distribution of the polymer being produced by the process at any given time. But the overall, or cumulative distribution does so with a large time constant under typical reaction conditions. Consequently, by the time a change in the cumulative distribution is detected in polymer sampled at the reactor outlet, it may be impossible to adjust the process to correct the distribution to the desired profile.

For the foregoing reasons the art is in need of a method of making bimodal or multimodal products with improved control and convenience.

### SUMMARY OF THE INVENTION

Embodiments of the invention address the above mentioned needs by providing a method of manufacturing a polymer composition that includes initiating a polymerization reaction at an initial set of polymerization parameters, determining a distribution of the at least one property of an intermediate polymer composition, adjusting the initial set of polymerization parameters based on the distribution of the at least one property to obtain a desired distribution of the at least one property in the polymer composition. In some embodiments of the invention, the method further includes comparing the distribution to a reference distribution. In addition, some embodiments further include minimizing the difference between the distribution and the reference distribution. One way to minimize the difference is by a least squares method. The methods described herein are useful for any polymer composition, but are particularly suitable for bimodal polymer compositions, such as, but not limited to, polyethylene and polypropylene homopolymerization and copolymerization processes.

In some embodiments, determining a distribution includes determining the cumulative distribution as predicted from a mathematical model of the distribution. In some embodiments, the distribution is determined by mathematically estimating at least one instantaneous distribution. In other embodiments, a plurality of instantaneous distributions are determined. In certain embodiments, the distribution is a molecular weight distribution, a comonomer content distribution, a long chain branching distribution, or a lamellar thickness distribution.

In some embodiments, determining a distribution includes online estimating the cumulative distribution from the polymerization parameters. Online estimation can include using mathematical models to determine the cumulative and instantaneous distributions.

In some embodiments, determining the distribution includes updating a distribution model based on one or more scalar properties of the intermediate polymer composition. Some useful scalar properties include melt index, flow index, melt flow ratio, density, or any other Theological property.

A mathematical model of the distribution can be used to adjust the measured distribution to a target, or reference, distribution. In some embodiments, discrete points or regions of the cumulative distribution are compared to the reference distribution.

Adjusting a polymerization reaction parameter may include adding a catalyst activity modifier. In other embodiments, adjusting the polymerization reaction parameter is accomplished by adding a chain transfer agent. Other embodiments include adjusting a plurality of polymerization reaction parameters.

Initiating the polymerization reaction can be accomplished by any suitable means. Typically, the polymerization process includes providing at least one catalyst. In some embodiments, the catalyst includes at least one multimodal catalyst system. Suitable multimodal catalyst systems include bimodal catalyst systems that include a Ziegler-Natta catalyst or at least one metallocene catalyst. In some embodiments, all catalysts are either Ziegler-Natta catalyst or metallocene catalysts. In other embodiments, a combination of Ziegler-Natta and metallocene catalysts are used. In some embodiments, the method includes a multimodal catalyst system that includes a metallocene catalyst that produces a low molecular weight portion of the polymer composition and a separate catalyst that produces a high molecular weight portion of the composition. In some embodiments, the catalyst system is a dual site catalyst system.

The processes described herein can be used in any type of polymerization reactor system. In some embodiments, the method is used in a series or parallel multi-reactor process. Or the process may be applied to a polymerization process used for the preparation of a unimodal resin. In embodiments where a unimodal resin is made, the catalyst should be selected accordingly.

Embodiments of the invention also provide a method of controlling the polymodal split of a polymerization process. The process includes conducting said polymerization process in the presence of at least two polyselective catalyst compositions, determining at least two process conditions, estimating the polymodal split from said process conditions, and adjusting said process conditions to obtain a desired polymodal split. Typical process conditions that can be determined are reaction temperature, catalyst feedrates, and the concentration of catalyst promoters or catalyst retarding agents.

Other embodiments provide a method of manufacturing a polymer composition that includes determining a distribution of the at least one property of an intermediate polymer composition, determining a target distribution of the polymer composition, and adding a polymer component to the intermediate polymer composition, wherein the amount of the polymer component is determined by minimizing the difference between the distribution of the at least one property of the intermediate polymer composition and the target distribution of the at least one property of the polymer composition.

Still other embodiments, provide a method of manufacturing a polymer composition that includes initiating a polymerization reaction at an initial set of polymerization parameters determining a polymer split from an instantaneous distribution of an intermediate polymer composition and adjusting the initial set of polymerization parameters based on the polymer split to obtain a desired split in the polymer composition.

### BRIEF DESCRIPTION OF THE DRAWINGS

FIG. 1 compares the molecular weight distribution of a desired polymer composition and the instantaneous molecular weight distribution at an intermediate point in the polymerization process.

FIG. 2 compares the desired molecular weight distribution with an intermediate distribution after control action based on the instantaneous distribution has been applied.

FIG. 3 shows the desired molecular weight distribution of the polymer composition and the evolution of the cumulative distribution of predicted molecular weight distributions during the polymerization process.

### DESCRIPTION OF EMBODIMENTS OF THE INVENTION

Embodiments of the invention provide a method of manufacturing a polymer composition that includes initiating a polymerization reaction at an initial set of polymerization parameters, determining a cumulative distribution of at least one property of an intermediate polymer composition and adjusting the initial set of polymerization parameters based on the cumulative distribution of the property to obtain a desired distribution of the property in the polymer composition. In some embodiments, determining a cumulative distribution includes using determining at least one instantaneous distribution derived from process data. In some embodiments, the property is the molecular weight distribution, comonomer distribution, lamellar thickness distribution, or long chain branching frequency of the polymer composition. Any property that can be related to process conditions or catalyst kinetics can be used.

Embodiments of the invention also provide a method of controlling the polymodal split, especially the bimodal split, of a polymerization process. The process includes conducting a polymerization process in the presence of at least two polyselective catalyst compositions, collecting at least two process conditions, estimating the polymodal split from said process conditions, and adjusting the process conditions to the obtain the desired polymodal split.

In the following description, all numbers disclosed herein are approximate values, regardless whether the word “about” or “approximately” is used in connection therewith. They may vary by up to 1%, 2%, 5%, or sometimes 10 to 20%. Whenever a numerical range with a lower limit, RL, and an upper limit Ru, is disclosed, any number R falling within the range is specifically disclosed. In particular, the following numbers R within the range are specifically disclosed: R=R_{L}+k*(R_{U}−R_{L}), where k is a variable ranging from 1% to 100% with a 1% increment, i.e. k is 1%, 2%, 3%, 4%, 5%, . . . , 50%, 51%, 52%, . . . , 95%, 96%, 97%, 98%, 99%, or 100%. Moreover, any numerical range defined by two numbers, R, as defined above is also specifically disclosed.

All references herein to elements or metals belonging to a certain Group refer to the Periodic Table of the Elements published and copyrighted by CRC Press, Inc., 1999. Also any reference to the Group or Groups shall be to the Group or Groups as reflected in this Periodic Table of the Elements using the IUPAC system for numbering groups. As used herein the term “comprising” is not intended to exclude any additional component, additive or step. For purposes of United States patent practice, the contents of any patent, patent application or publication referenced herein are hereby incorporated by reference in their entirety, especially with respect to the disclosure of synthetic techniques and general knowledge in the art.

As used herein the term “multimodal” means that a polyolefin resin has two or more distinct ranges of molecular weight , density, comonomer content distribution, or long chain branching distribution. “Bimodal” as applied to polyolefin resins usually means that the resin has two distinct ranges of molecular weight or density comonomer content distribution, or long chain branching distribution.

The term “distribution” is associated with a property of a polymer composition and is intended to describe the character of the property as a function of the polymer composition. Any random property that varies from polymer molecule to polymer molecule can be thought of as possessing a distribution. The molecular weight distribution, comonomer incorporation distribution, long chain branching distribution are examples of distributions that are useful in some embodiments of the invention. But references herein to a distribution should not be construed to be limited to those particular properties; any other polymer property may also be used.

Embodiments of the invention provide a mathematical model of a polymerization process that is used to control or improve product quality and reliability by employing one or more distribution characteristics of an intermediate polymer resin. In contrast to methods that rely on directly measuring or estimating scalar properties such as melt index (I₂) or flow index (I₂₁), employing information regarding the distribution of a polymer property across a substantial portion of the polymer resin provides a useful method for manipulating the properties of multi-modal products in order to achieve target product specifications.

In some embodiments, the distribution of a polymer property can be directly measured. For instance, in some embodiments, the polymer may be directly sampled The sample is analyzed and a distribution is obtained from the analysis. In one embodiment, the molecular weight distribution of an intermediate polymer resin is determined. Based on the measured distribution of molecular weights of the intermediate polymer resin, one or more polymerization parameters are adjusted so that the distribution of molecular weights produced by the process is closer to the desired molecular weight distribution of the final polymer composition. Some factors or process conditions that affect a distribution in polymer processes include catalyst concentration, reaction temperature, monomer concentration or feed rate, chain terminating agents, the effect of catalyst activating and deactivating agents. One skilled in the art understands that there are a variety of other factors that can be measured and manipulated to affect a particular distribution that is made in a polymerization reaction.

In other embodiments, a distribution is estimated from process parameters based on mathematical relationships in the polymerization process. Mathematical relationships based on one or more of catalyst, monomer, and polymerization reactor properties are developed to construct instantaneous distributions of the polymer being produced in the reactor by a given catalyst. Instantaneous distributions can be thought of as a snapshot that captures the distribution of a polymer composition being produced in a reactor at any time in the polymerization process. The sum of the individual instantaneous distributions for each catalyst site are used to construct the cumulative distribution of the polymer composition, i.e. the distribution that exists in the polymerization reactor at an arbitrary time. Some embodiments use relationships described in “Simulating Cumulative Distributions under Transient Conditions in Well-Mixed, Continuous and Batch Polymerization Reactors.” Sachs, W; Macromol. Symn. 2004, 206, 29-42, incorporated herein by reference in its entirety.

The molecular architecture of polyolefins is described by probability distribution(s) of structural features of a polymer chain. Instantaneous distributions describe the relative number or mass-weighted frequency with which these structural features occur jointly, marginally, or conditionally in polymer chains produced in a polymerization reaction during a short period of time, between ξ and ξ+Δξ.

In multi-site or mixed catalyst systems, the instantaneous distribution of the molecular architecture of polymer formed during a short interval of time is made up of contributions from the instantaneous distributions for polymer produced by each catalyst site or component. Because the individual sites of a multi-site-type catalyst and single-site components of a mixed catalyst system are mathematically equivalent no distinction between these sites is made. And both are referred to herein as ‘sites’ with the understanding that individual catalyst components in a mixed catalyst system can be made up of multiple sites.

The molecular architecture of the polymer formed by the k-th catalyst site is governed by the instantaneous joint p-variate distribution of x, uₖ (x, θₖ(ξ)), where x is a vector of random structural characteristics. One skilled in the art recognizes that when x is comprised of continuous random variables, u is more properly referred to as a probability density function. Random structural characteristics include, but are not limited to, molecular weight and chemical composition, and θₖ(ξ) is a vector of m time-dependent parameters that are functions of the kinetics and mechanisms of polymerization and reactor conditions.

x=(ₗ, . . ., xₚ) (1)

θₖ(ξ)=(θ_{k,1}(ξ), . . . , θ_{k,m}(ξ)) (2)

Normally, the functional form of uₖ will be the same for each catalyst site.

The instantaneous distribution of x in a transition—metal catalyzed olefin polymerization reaction is comprised of two contributions—one from the distribution of x for newly terminated polymer chains; the second from the distribution of x associated with live, actively growing polymer chains. In most polyolefin systems of commercial interest, the mass fraction of live polymer in the reactor is very small, and its contribution to the cumulative distribution of x at the reactor outlet can be neglected. Hence, it is the instantaneous distribution of x for the dead polymer that is of primary interest, although in many cases, the instantaneous distributions of the molecular architectures of live and dead polymer chains are identical.

These distributions can be univariate or multivariate, depending on the dimensionality of x; they can also be discrete or continuous, or discrete in some dimensions and continuous in others, depending on the nature of the random structural characteristics represented by x. There may also be more than one instantaneous, and hence cumulative distribution of interest in a given problem.

The manner in which individual instantaneous distributions are combined to yield a composite instantaneous distribution is referred to as a ‘mixing rule’. From elementary statistical theory, the instantaneous distribution, h(x, θ(ξ)), of the molecular architecture of polymer formed during a short interval of time (ξ, ξ+Δξ) by an n-site catalyst can be written as a linear mixture distribution,

$$\begin{matrix}h ( x , θ ( ξ ) ) = {\sum }_{k} {α}_{k} ( ξ ) \cdot {u}_{k} ( x , {θ}_{k} ( ξ ) ) & ( 3 ) \\ where , & \\ {\sum }_{k} {α}_{k} ( ξ ) = 1 & ( 4 )\end{matrix}$$

and

θ(ξ)=(θ₁(ξ), α₁(ξ), . . . , . . . , θₙ(ξ),Δₙ(ξ) (5)

The linear mixing coefficients, αₖ(ξ), which determine the relative contribution of each individual instantaneous distribution, are also time-dependent functions of the kinetics and mechanisms of polymerization and reactor conditions.

For mass-weighted distributions, the linear coefficients in equation (3) are the instantaneous ‘splits’ or weight fractions, Sₖ, of polymer produced by each of the catalyst sites, where

$$\begin{matrix}{S}_{k} = \frac{{P}_{R}^{k}}{{P}_{R}^{T}} and {P}_{R}^{T} = {\sum }_{k} {P}_{R}^{k} & ( 6 ) \\ and & \\ h ( x , θ ( ξ ) ) = {\sum }_{k} {S}_{k} ( ξ ) \cdot {u}_{k} ( x , {θ}_{k} ( ξ ) & ( 7 )\end{matrix}$$

where P_{R}^{k} is the instantaneous mass rate of production of polymer by live catalyst sites of type k and P_{R}^{T} is the total mass rate of polymer production.

The concepts behind the use of mixing rules and instantaneous distributions can be extended to other polymer properties. It is, for example, legitimate to consider instantaneous measures of desired product characteristics including instantaneous properties such as I₂ and I₂₁, and instantaneous solid-state properties such as density. Mixing rules for combining instantaneous product properties of olefin polymer generated by multi-site type catalysts are disclosed by McAuley, K. B. and J. F. MacGregor in “On-Line Inference of Polymer Properties in an Industrial Polyethylene Reactor”, AIChE J., 37, 825-835 (1991) and “Nonlinear Product Property Control in Industrial Gas-Phase Polyethylene Reactors”, AIChE J., 39, 855-866 (1993), the entire disclosures of which is incorporated herein by reference. For example, dynamic models for melt index (I₂) and density control in industrial gas-phase polyethylene reactors using a combination of fundamental kinetic models and semi-empirical structure-property models are described. Empirical steady-state regression models relating the logarithm of melt index to process conditions, and a semi-empirical log-linear mixing rule for melt index in order to develop an online inferential scheme for predicting and controlling melt index in an industrial high-density polyethylene process as taught by Ogawa in “Quality Inferential Control of Industrial High Density Polyethylene Process”, J. Process Control, 9, 51-59 (1999) can also be used and the disclosure of which is incorporated herein by reference in its entirety. Other methods for determining instantaneous property distributions that are useful in embodiments of the invention are described in U.S. Pat. No. 6,093,211 and WO 99/53387, the disclosures of which are incorporated herein in their entirety.

The time dependence of the cumulative distribution of x for polymer produced in a well-mixed continuous polymerization reactor by a catalyst system with 11 components can be determined. The cumulative distribution of x in the polymer bed of a well-mixed reactor at time t+Δt is considered. If g(x,t) is the cumulative distribution of x at time t, then using a linear mixing rule with a mass balance on polymer in the reactor bed, the time derivative of g (x, t) can be written as,

$$\begin{matrix}\begin{matrix}\frac{ⅆ g ( x , t )}{ⅆ t} = \frac{1}{{W}_{b}} \cdot [ {P}_{R}^{T} \cdot h ( x , θ ( t ) ) - {q}_{0} \cdot g ( x , t ) - g ( x , t ) \cdot ( {P}_{R}^{T} - {q}_{0} ) ] \\ = \frac{{P}_{R}^{T}}{{W}_{b}} [ h ( x , θ ( t ) ) - g ( x , t ) ]\end{matrix} & ( 8 ) \\ or , expanding h , & \\ \frac{ⅆ g ( x , t )}{ⅆ t} = \frac{{P}_{R}^{T}}{{W}_{b}} \cdot ( ( {\sum }_{k} {S}_{k} \cdot {u}_{k} ( x , {θ}_{k} ( t ) ) ) - g ( x , t ) ) & ( 9 )\end{matrix}$$

where P_{R}^{T} is the instantaneous mass rate of production of polymer by live catalyst in the reactor bed, h(x, θ(t)) the instantaneous distribution of x, q₀ the mass rate of discharge of bulk polymer at the reactor outlet, and W_{b} the polymer bed mass, all at time t. Under typical conditions of constant bed weight control,

P_{R}^{T}=q₀ (10)

Substituting q₀ for P_{R}^{T} in equation (9), and noting that q₀/W_{b} is the instantaneous bed turnover rate, or equivalently, the inverse of the instantaneous residence time, τ,

$$\frac{ⅆ g ( x , t )}{ⅆ t} = \frac{1}{τ} \cdot [ ( {\sum }_{k} {S}_{k} {u}_{k} ( x , {θ}_{k} , ( t ) ) - g ( x , t ) ] \qquad ( 11 )$$

This result allows the estimation of cumulative distributions from typically measured process conditions. And equation (9) provides a convenient mathematical platform for online control because equation (9) is readily solved online with minimal data storage requirements by recursive finite-difference methods.

For constant h and τ, the convergence of g to h is a first-order process with time constant, τ, and at a steady state, the cumulative distribution converges to the instantaneous distribution. But where the mass of the polymer bed, the instantaneous distribution, the polymer production rate P_{R}^{T}, and the bed turnover rate, τ⁻¹, vary with time in response to process disturbances equation (11) can be solved for g(x, t),

$$g ( x , t ) = \frac{{W}_{b} ( {t}_{0} ) \cdot g ( x , {t}_{0} ) exp ( - {\int }_{{t}_{0}}^{t} \frac{d ϕ}{τ} )}{{W}_{b} ( t )} + \\ \frac{{\int }_{{t}_{0}}^{t} {P}_{R}^{T} ( ξ ) \cdot h ( x , θ ( ξ ) ) \cdot exp ( - {\int }_{ξ}^{t} \frac{d ϕ}{τ} )}{{W}_{b} ( t )} \qquad ( 12 )$$

which is a convolution integral for cumulative distributions.

These models can be applied to use instantaneous distributions to control product properties. Of the many random structural characteristics that can affect product performance, the two most commonly cited structural characteristics for polyethylenes are molecular weight, and short-chain branch frequency. When considered separately, these can each be described by univariate marginal distributions. Under conditions where chain transfer is the predominate mechanism for termination of growing chains, it is well known that the mass-weighted instantaneous molecular weight distribution for polyethylenes produced by single-site transition metal catalysts can be approximated by an appropriately weighted Schultz-Flory distribution,

$${W}_{k} ( M W ) = \frac{M W}{{M}_{N , k}^{2}} exp [ - \frac{M W}{{M}_{N , k}} ] ≡ {u}_{k} ( x , {θ}_{k} ( ξ ) ) \qquad ( 13 )$$

where x and θₖ(ξ) in uₖ are the one-dimensional vectors,

x=(MW) and θₖ(ξ)=(M_{N,k}) (14)

The Schultz-Flory distribution is a one-parameter exponential distribution defined by M_{N,k}. The molecular weight, MW, is a random variable and M_{N,k} is the time-dependent instantaneous number-average molecular weight of polyethylene produced by catalyst sites of type k.

The instantaneous mass-weighted chemical composition distribution for polyethylenes produce by a single-site transition metal catalyst is given by

$${W}_{k} ( y ) = \frac{3 ( 1 + {Δ}_{k} y )}{4 \sqrt{2 {β}_{k} \overline{{m}_{M , k}} / {M}_{N , k}} \cdot {( 1 + \frac{{y}^{2}}{2 {β}_{k} \overline{{m}_{M , k}} / {M}_{N , k}} )}^{5 / 2}} \qquad ( 15 )$$

βₖ=\overline{F_{1,k} F_{2,k}}K (16)

\overline{F_{1,k}}+\overline{F_{2,k}}=1 (17)

K=\sqrt{1+4F_{1,k}F_{2,k}(r_{1,k}r_{2,k}−1)} (18)

\overline{m_{M,k}}=m_{M1}\overline{F_{1,k+}}m_{M2}\overline{F_{2,k}} (19)

$${Δ}_{k} = \frac{( {m}_{M1} - {m}_{M2} )}{\overline{{m}_{M , k}}} \qquad ( 20 )$$

F_{1,k} and F_{2,k} are the average mole fractions of monomer 1 (ethylene) and 2 (comonomer) incorporated instantaneously into ethylene-ce-olefin copolymer produced by catalyst sites of type k, r_{1,k} and r_{2,k} a are the corresponding reactivity ratios from a terminal or first-order Markov model for copolymerization, m_{M1} and m_{M2} the molecular weights of monomer 1 and 2, m_{M,k} the molecular weight of the instantaneous average monomer repeat unit incorporated by these sites, and the random variable y is the deviation in the mole fraction of monomer 1 incorporated from its mean value, F_{1,k}.

$${W}_{k} ( {F}_{2} ) = \frac{3 ( {m}_{M1} ( 1 - {F}_{2} ) + {m}_{M2} {F}_{2} )}{4 \overline{\overline{{m}_{M , k}} \sqrt{2 {β}_{k} {m}_{M , k} / {M}_{N , k}}} \cdot {( 1 + \frac{{( \overline{{F}_{2 , k}} - {F}_{2} )}^{2}}{2 {β}_{k} \overline{{m}_{M , k}} / {M}_{N , k}} )}^{\frac{5}{2}}} ≡ {u}_{k} ( x , {θ}_{k} ( ξ ) ) \qquad ( 21 )$$

Both the Shultz-Flory distribution and the chemical composition distribution for polymer produced by catalyst sites of type k are functions of the instantaneous number average molecular weight, M_{N,k}, which is a function of process conditions,

$${M}_{N , k} = \overline{{m}_{M , k}} \cdot \frac{{R}_{p}^{k}}{{R}_{CT}^{k}} \qquad ( 22 )$$

where Rₚ^{k} and R_{CT}^{k} are the instantaneous molar rates of chain propagation and termination, respectively. When the principle chain transfer pathways for each catalyst can be identified, expressions for Rₚ^{k}/R_{CT}^{k} can be derived. For example, the instantaneous molar rate of propagation in a copolymerization is governed by rates of the propagation pathways, k_{p1,k} and k_{p2,k}, and the concentration of the monomers, M₁ and M₂. In a process where β-hydride elimination, chain transfer to hydrogen, and chain transfer to monomer and comonomer are important in terminating the polymer chains, then the molar rate of chain termination will be governed by the rate constant for each of these processes. The ratio of the rate of chain propagation to chain termination follows the equation:

$$\frac{{R}_{P}^{k}}{{R}_{CT}^{k}} = \frac{{k}_{p1 , k} {M}_{1} + {k}_{p2 , k} {M}_{2}}{{k}_{β , k} + {k}_{H , k} + {k}_{{M}_{1} , k} {M}_{1} + {k}_{{M}_{2} , k} {M}_{2}} \qquad ( 23 )$$

where k_{β,k} is the rate of β-hydride elimination, k_{H,k} is the rate of chain termination by hydrogen, K_{M1,k} is the rate of chain termination by monomer 1 and k_{M2,k} is the rate of chain termination by monomer 2. H, M₁, and M₂ are the concentration of hydrogen, monomer 1 and monomer 2, respectively.

The instantaneous number average molecular weight M_{N,k} is given by the formula:

$$\begin{matrix}{M}_{N , k} = \frac{\overline{{m}_{M1 , k}}}{( \frac{{k}_{β , k}}{{k}_{p1 , k}} \cdot \frac{1}{{M}_{1}} + \frac{{k}_{H , k}}{{k}_{p1 , k}} \cdot \frac{H}{{M}_{1}} + \frac{{k}_{{M}_{1} , k}}{{k}_{p1 , k}} \cdot \frac{{k}_{{M}_{2} , k}}{{k}_{p1 , k}} \frac{{M}_{2}}{{M}_{1}} )} & ( 24 ) \\ \overline{{m}_{M1 , k}} = ( \frac{{m}_{M2} {M}_{2}}{1 + {m}_{M1} {m}_{1}} \cdot {r}_{k}^{- 1} ) \cdot {m}_{M1} & ( 25 )\end{matrix}$$

where \overline{m_{M1},}k is the instantaneous average molecular weight increase per mole of monomer 1 incorporated in the polymer by active sites of type k, k_{p1,k} and k_{p2,k} the propagation rate constants for monomer 1 and 2, respectively, rₖ the reactivity ratio for monomers 1 and 2, M₁, M₂, and H the concentrations of monomer 1 and 2, and hydrogen, respectively, in the vicinity of active catalyst sites, k_{β,k} the rate constant for chain transfer by β-hydride elimination, and k_{H,k}, k_{M1,k} and k_{M2,k} the rate constants for chain transfer to hydrogen, monomer and comonomer, respectively. For single-site catalysts, equation (24) captures the dependence of the molecular weight of ethylene-α-copolymers on process variables such as monomer concentration, hydrogen-ethylene ratio, and comonomer ratio. Equations (23) and (24) neglect the chain termination that takes place when live polymer spontaneously deactivates or is discharged at the reactor outlet—a reasonable approximation for most transition metal catalysts and for typical residence times for fluid bed reactors. Should the assumptions underlying equation (24) prove overly restrictive, they may be modified to include terms that account for neglected pathways.

The instantaneous marginal chemical composition distribution in equation (20) is well approximated by a δ-function located at:

$${F}_{2} = \overline{{F}_{2 , k}} = \frac{{R}_{p2}^{k}}{{R}_{pl}^{k} + {R}_{p2}^{k}} = \frac{( {r}_{1 , k} + {r}_{2 , k} \frac{{M}_{2}}{{M}_{1}} ) \cdot \frac{{M}_{2}}{{M}_{1}}}{{r}_{1 , k} \cdot ( {r}_{1 , k} + \frac{{M}_{2}}{{M}_{1}} ) + ( {r}_{1 , k} + {r}_{2 , k} \frac{{M}_{2}}{{M}_{1}} ) \cdot \frac{{M}_{2}}{{M}_{1}}} \qquad ( 26 )$$

where Rₚ₁^{k} and Rₚ₂^{k} are the instantaneous molar rates of polymerization of monomer 1 and 2 by catalyst sites of type k. In the case of copolymerization reactions for which r_{1,k}r_{2,k}=1, equation (26) reduces to,

$$\overline{{F}_{2 , k}} = {( {r}_{k} + \frac{{M}_{2}}{{M}_{1}} )}^{- 1} \cdot \frac{{M}_{2}}{{M}_{1}} \qquad ( 27 )$$

If circumstances warrant, the instantaneous joint bivariate distribution for molecular weight and chemical composition (the Flory-Stockmayer distribution) can be used in place of equations (23) and (32) as described in “Analyzing TREF data by Stockmayer's bivariate distribution”, Macromol. Theory Simul., 4, 305-324 (1995) by Soares et al.; “Simulating joint chain length and composition fractions from semi-batch ethylene copolymerization experiments”, Polym. React. Eng., 6, 113-142 (1998) by Shaw; or “Statistical Issues in Kinetic Modelling of Gas-Phase Ethylene Copolymerization”, Ph.D. Thesis, Department of Chemical Engineering, Queen's University, 1999 also by Shaw, the disclosures of which are incorporated herein by reference in their entirety.

Similar derivations of the polymer split in a bimodal system show that the time dependence of the split is modeled by the following formula:

$$\frac{ⅆ {S}_{c}}{ⅆ t} = \frac{1}{{W}_{b}} \cdot [ {P}_{R}^{HMW} - {q}_{o} \cdot {S}_{c} - {P}_{R} \cdot {S}_{c} + {q}_{o} \cdot {S}_{c} ] = \frac{{P}_{R}}{{W}_{b}} \cdot [ S - {S}_{c} ] \qquad ( 28 )$$

where S_{c} is the cumulative split, W_{b} is the polymer mass of the bed, P_{R}^{HMW} is the instantaneous mass rate of production of the high molecular weight polymer catalyst, qₒ is the mass rate of discharge of bulk polymer from the reactor outlet, P_{R} is the instantaneous total mass production rate, and S is the instantaneous split.

In some embodiments Equations (13) and (20), combined with equation (7) and expressions for the polymer split can be used to track instantaneous molecular weight and chemical composition distributions for mixed-catalyst systems in a polymerization process. Under transient conditions, cumulative molecular weight and chemical composition distributions can also be tracked using equation (9). In some embodiments, other instantaneous distributions known in the art, including empirical correlations are used.

Mathematical descriptions of a staged reactor system can also be derived. For example, the time dependence of the cumulative distribution in the first and second reactors of a two-stage reactor are given by:

$$\frac{ⅆ {g}_{1}}{ⅆ t} = \frac{{P}_{R , 1}}{{W}_{b , 1}} ( {h}_{1} - {g}_{1} ) ; \frac{ⅆ {g}_{2}}{ⅆ t} = \frac{{q}_{o , 1}}{{W}_{b , 2}} ( {g}_{1} - {g}_{2} ) + \frac{{P}_{R , 2}}{{W}_{b , 2}} ( {h}_{2} - {g}_{2} ) \qquad ( 29 )$$

The time dependencies of the polymer bed weights are given by:

$$\begin{matrix}\frac{ⅆ {W}_{b , 1}}{ⅆ t} = {P}_{R , 1} - {q}_{o , 1} & ( 30 ) \\ \frac{ⅆ {W}_{b , 2}}{ⅆ t} = {q}_{o , 1} + {P}_{R , 2} - {q}_{o , 2} & ( 31 )\end{matrix}$$

And the time dependence of the cumulative split can be determined from:

$$\frac{ⅆ {S}_{c}}{ⅆ t} = ( \frac{{q}_{o , 1} + {P}_{R , 2}}{{W}_{b , 2}} ) ( S - {S}_{c} ) , where S = \frac{{q}_{o , 1}}{{q}_{o , 1} + {P}_{R , 2}} . \qquad ( 32 )$$

As described above, g and h are any pair of cumulative and instantaneous properties that obey linear mass-mixing rules. Again S_{c} is the cumulative split, W_{b} is the polymer mass of the bed, q₀ is the mass rate discharge of bulk polymer from the reactor outlet, P_{R} is the instantaneous total mass production rate, S is the instantaneous split, and subscripts 1 and 2 refer to the first and second reactors respectively.,

Experimental measurement of joint distributions of two or more random structural features can be accomplished. In order to characterize a p-variate distribution it is necessary to fractionate a polymer with respect to p-1 of its random structural features, or to show that they are independent. Temperature Rising Elution Fractionation-Size Exclusion Chromatography (TREF-SEC) provides the simplest example for ethylene-α-olefin copolymers. Temperature Rising Elution Fractionation is described, for example, in Wild et al, Journal of Polymer Science, Poly. Phys. Ed., Vol. 20, p. 441 (1982), in U.S. Pat. No. 4,798,081, or as is described in U.S. Pat. No. 5,008,204, the disclosures of which is incorporated herein by reference. TREF is used to fractionate polyethylene with respect to chemical composition. Narrow chemical composition fractions are then characterized with their molecular weight by SEC, a well known technique. The joint bivariate distribution of molecular weight and chemical composition for these polymers can be constructed from the resulting conditional molecular weight distributions and the marginal chemical composition distribution of the polymer determined by TREF as described in “Measurement of the Bivariate Distribution of Composition and Molecular Weight for Binary Copolymers—A Review”, Polym. React. Eng., 1, 171-201 (1992-93) by Estrada et al. and “Analyzing TREF data by Stockmayer's bivariate distribution”, Macromol. Theory Simul., 4, 305-324 (1995) by Soares et al., the disclosures of which are incorporated herein by reference.

Most techniques that have been developed for characterization of polymer distributions yield information about only one random structural feature. For example, molecular weight by SEC; chemical composition by TREF; and comonomer sequences by 13C NMR. Some techniques and multi-detector instruments can also be used to determine the mean values of certain conditional distributions. For example, Size Exclusion Chromatography-Fourier Transform Infrared Spectroscopy (SEC-FTIR) can be used to determine the average chemical composition (or short chain branch frequency) of ethylene-α-copolymers as a function of molecular weight, as described in “A new methodology for studying multiple-site-type catalysts for the copolymerization of olefins”, Macromol. Chem. Phys., 197, 3383-3396 (1996) by in Soares, J. B. P, et al., the disclosure of which is hereby incorporated by reference in its entirety.

The relationship between predicted molecular weight distributions derived by combining equations (7) and (23), and experimentally measured distributions determined by SEC is straightforward and is described in “The Separation of SEC Curves of HDPE into Flory Distributions”, J. Appl. Polym. Sci., 50, 551-554 (1993) by Vickroy, et al; “Molecular Weight Distributions of Linear Polymers: Detailed Analysis from GPC Data”, J. Polym. Sci., Polym. Chent., 33, 227-237 (1995) by Kissin; and in “Deconvolution of chain-length distributions of linear polymers made by multiple-site-type catalysts”, Polymer, 36, 2257-2263 (1995) by Soares and Hamielec; each of these disclosures is incorporated herein in its entirety. The relationship between predicted chemical composition distributions derived by combining equations (7) and (21), and experimentally measured distributions is described in “Modelling of Fractionation in CRYSTAF using Monte Carlo Simulation of Crystallizable Sequence Lengths: Ethylene/1-Hexene Copolymers Synthesized with Single-Site-Type Catalysts”, J. Appl. Polym. Sci. (2001) by Beigzadeh, et al. and “Crystallization fractionation analysis (CRYSTAF) of poly(ethylene-co-l-octene) made with single-site-type catalysts: A mathematical model for the dependence of composition distribution on molecular weight”, Macromol. Chem. Phys., 199, 1917-1926 (1998) by Soares, et al. When correlating experimentally measured distributions, care should be taken to properly calibrate the data so that they represent the chemical composition distribution of ethylene-α-copolymers as described in “Temperature rising elution fractionation of linear polyolefins”, Polymer, 36, 1639-1654 (1995) by Soares et al. and “Characterization of Homogeneous Ethylene/1-Octene Copolymers Made with a Single-Site Catalyst. CRYSTAF Analysis and Calibration”, J. Polym. Sci., Polym. Chem., 37, 89-93 (1999)by Monrabel, et al.

With this understanding, some embodiments of the invention control the molecular architecture of the olefin copolymer. In other embodiments, the process is used to control or adjust the polymer's end-use properties that are related to one or more of its cumulative distributions. In other embodiments, both the molecular architecture and the end-use properties are adjusted or controlled via the use of these models for deriving the instantaneous and cumulative distributions of certain polymer properties. Methods for and effects of polymerization parameters for controlling polymerization processes are discussed in to Embirucu, et al.(1996), Bindlish (1999), and Ohshima and Tanigaki (2000), the disclosures of which are incorporated herein by reference in their entirety. One skilled in the art understands that a number of factors, including but not limited to, monomer (or comonomer) concentration, the use of other transfer agents, reactor temperature, pressure, polymer concentration, and catalyst(s) used will affect the molecular architecture of the polymer. For example, where long chain branching is desired, higher polymerization temperatures, lower comonomer concentrations, higher polymer concentration, and/or using catalysts which can generate a relatively high percentage of vinyl end groups are useful. Conversely, a lower level of long chain branching may be obtained when a polymerization reaction is operated at a lower temperature, a higher comonomer concentration, a lower polymer concentration, and using catalysts which can generate a relatively low percentage of vinyl end groups.

By understanding how polymerization parameters affect the molecular architecture of the polymer or its properties, the models for instantaneous and cumulative distributions are used to control and/or adjust the polymerization process in order to obtain a polymer product having desired properties with improved consistency. In some embodiments, the models developed herein employ fundamental kinetic and process parameters to control one or more average molecular properties or distribution moments that dominate product performance, such as weight average molecular weight, polydispersity, and average chemical composition long chain branching frequency, comonomer content, or any other feature that affects either the polymer architecture or the resulting properties of the polymer. In some embodiments, scalar properties such as melt index or flow index are determined from the fundamental kinetics and process parameters, or in some embodiments empirical correlations, and are used to control or adjust the polymer process to produce a product having a desired scalar property or distribution.

In some embodiments, experimentally determined reference distributions of a property or feature of the desired product are used to control or adjust the distribution of the property or feature of the polymer in the polymerization process. In some embodiments employing mixed-catalyst systems, the references distribution may be augmented by known or measured distributions for polymers produced by the individual catalyst components. Embodiments of the invention use these experimentally determined distributions.

In some embodiments, the reference distributions are employed as a discrete grid of values for control or adjustment purposes. In embodiments the distributions are used as discrete values in x-space and a control strategy implemented in which control actions are taken to minimize the distance between the reference distribution(s) for the target product and their predicted instantaneous counterparts. For instance, one embodiment uses a grid of values describing the desired molecular weight distribution of the product and a corresponding array of values based on the instantaneous or cumulative distribution. In this case the molecular weight distribution is the x-space. In some embodiments, the distance is minimized by a least squares method. Other embodiments use a chi-squared method. The distance can also be minimized using objective functions for the desired fit. And the invention is not limited by any particular method of minimizing the difference between the values of the reference distributions and the corresponding values for the instantaneous or cumulative distribution.

In other embodiments, the values of the distribution are partitioned into regions or areas, not necessarily contiguous, which represent ranges of structural variables that are important determinants of product performance. The area or weight fraction of polymer produced in each of these regions is computed from one or more reference distributions and a control strategy implemented in which control actions are taken to minimize the distance between these target weight fractions and those obtained from the predicted instantaneous distributions. From the difference in the reference distribution and the instantaneous distribution, a change in a control function that will minimize the difference between the reference distribution and the distribution as estimated by the instantaneous or cumulative distribution is determined. The control parameter is adjusted to minimize this difference. Control functions include catalyst concentration, monomer concentration, temperature or any other parameter of the polymerization process. Any minimization procedure may be used.

In some embodiments, scalar parameters such as melt flow or flow index can be computed from the one or more reference distributions and a control strategy implemented that minimizes the difference between the scalar parameter of the product and that estimated from the instantaneous or cumulative distribution of the intermediate product. In some embodiments, the scalar parameter is the weight average molecular weight, M_{w}, the number average molecular weight, Mₙ, the molecular weight distribution or polydispersity, MWD, the density or the split.

In embodiments where discrete grids or regions of the x-space are used to approximate the entire distribution or regions of the distribution, two additional system states for each grid point or region are generated—one for the density or integral of the instantaneous distribution, h(x, θ(t)), and one for the density or integral of the cumulative distribution, g(x, ξ). Equations for these additional system states can be appended to and solved simultaneously with the system of differential-algebraic equations comprising the model of the process as described in “Simulating joint chain length and composition fractions from semi-batch ethylene copolymerization experiments”, Polym. React. Eng., 6, 113-142 (1998) by Shaw, et al (1998) and “Statistical Issues in Kinetic Modelling of Gas-Phase Ethylene Copolymerization”, Ph.D. Thesis, Department of Chemical Engineering, Queen's University, 1999 by Shaw, the disclosures of which are incorporated herein by reference in their entirety.

In some embodiments, the reference distribution, instantaneous distribution, cumulative distribution or a combination thereof are approximated by a set of scalar properties of the polymer mixture. For example, in some embodiments the molecular weight distribution of polyethylene produced by a binary mixture of single-site catalysts is adequately determined by the number average molecular weight of polyethylene produced by each catalyst, M_{N,1}, M_{N,2}, or equivalently, their weight average molecular weights, and split, S₁. In such embodiments, the difference between the set of scalar properties of the reference or desired product and those determined from the instantaneous or cumulative distribution is minimized by any suitable method.

One skilled in the art will recognize that the number of points along a discretized reference distribution will far exceed the number of process variables that can be manipulated to maintain or adjust the distribution of the intermediate product. In such over determined systems, one or more objective functions to determine appropriate control action are used. In other embodiments, multiple properties or structural features are correlated to regions of the reference distribution. In these cases, variable weighting according to an arbitrary scheme may be used to minimize the difference between the reference distribution and the instantaneous distribution or cumulative distribution. Or in some embodiments, the variable weighting is selected to overcorrect, that is move the distribution past the desired value. Such embodiments have the advantage of more quickly moving the distribution toward the desired value.

In some embodiments controlling or adjusting the physical properties related to specific uses can be based on fundamental dynamic process models in conjunction with static quantitative structure-property models. Some embodiments use the models described in “Nonlinear Model Predictive Control of End-Use Properties in Batch Reactors Under Uncertainty”, Ph.D. Thesis, Department of Chemical Engineering, Lehigh University, 2001 by Valappil (2001), incorporated herein by reference in its entirety. A similar approach is described for a continuous polymerization reactor in “On-Line Modelling and Predictive Control of an Industrial Terpolymerization Reactor”, Int. J. Control, 59, 711-729 (1994) by Ogunnaike, the disclosure of which is incorporated herein by reference in its entirety. Dynamic process models are used to track summary measures of polymer structure, e.g., distribution moments, which are then mapped to end-use properties using one or more quantitative structure-property relationships. In some embodiments of the invention, discretized cumulative distributions of polymer chain architecture are employed as input to these models and the difference between the desired properties and the properties of the intermediate resin is minimized by adjusting appropriate factors.

In some embodiments of the invention, the difference between intermediate distributions or scalar parameters relating to both molecular architecture and end-use properties are minimized. In other embodiments, consistent product properties are controlled by controlling one or more process parameters to minimize the difference of the distribution between the desired polymer and the intermediate polymer. In some embodiments, properties of multi-modal resins are controlled or adjusted by controlling a process parameter to minimize the difference between distributions that describe the molecular architecture of multi-modal products.

In some embodiments, the reference distributions are used in conjunction with scalar properties of the desired polymer product. The process parameters are adjusted to simultaneously minimize the difference between the reference distribution and one or more scalar properties of the desired resin and the instantaneous or cumulative distribution and the scalar properties of the intermediate product and the desired resin. Scalar properties that relate to properties of the desired product include melt index, flow ratio and density. But the use of any other scalar property is envisioned.

Embodiments of the invention also encompass the use of reference distributions for molecular weight and chemical composition, or a reference parameter set comprised of the weight average molecular weight and chemical composition of polymer produced by each catalyst, along with split. In such embodiments, the reference distributions are coupled with properties such as melt index, flow ratio and density, using static structure-property models.

Some embodiments of the invention control and adjust the process parameter using the concept of reachable regions as described in “Nonlinear Model Predictive Control of End-Use Properties in Batch Reactors Under Uncertainty”, Ph. D. Thesis, Department of Chemical Engineering, Lehigh University, 2001 by Valippil, incorporated herein by reference in its entirety. As described therein, the desired properties or combinations thereof is considered reachable from a given process state if the desired properties can be obtained by adjusting process parameter. There are cases where the entire set of desired properties is not reachable by adjusting process variables even though one or more of the desired properties are reachable.

One skilled in the art will appreciate that several assumptions apply to the use of instantaneous distributions First, the time scales for establishing quasi-steady-state conditions for live polymer species must be short in relation to the reactor dynamics being modeled. Analytical expressions for many instantaneous distributions have been derived by applying the quasi-steady-state approximation to the rate expressions for live polymer species. The Schultz-Flory, Stockmayer, Flory-Stockmayer, and several long-chain branching distributions fall into this category. Second, the lifetimes of growing polymer chains must be short in relation to the reactor dynamics being modeled. This ensures stable instantaneous distributions during the finite interval, (ξ, ξ+Δξ). For modern catalyst systems, chain lifetimes on the order of seconds are common. And the kinetics of polymerization are spatially independent and homogeneous. In other words, mixing is complete on time scales that are short, and reactant concentrations and temperatures are uniform at the particle level. So particle-level dynamics and distributed-reactor effects can be ignored.

In some embodiments, cumulative molecular weight distributions inferred from process parameters and models can be used to control the production of high-density high molecular weight bimodal polyethylene in a staged reactor system as well. For each reactor in the staged reactor process, simple reaction and molecular weight distribution models may be formulated which relate the instantaneous molecular weight distribution of the resin produced in each reactor to catalyst feed rate and reactor conditions. Depending on the reactors, the models may be the same or different for each stage of the reactor.

In some embodiments cumulative distributions are used to aid in formulating blends. Blending small amounts of off-grade resin inline with new production is often used to consume inventories of off-grade resin, thereby achieving substantial cost savings. A variety of constraints may be applied to maintain consistently acceptable quality of the blended resin. An absolute upper limit is placed on the amount of off-grade resin that is acceptable in blends of new production. Inferred and measured molecular weight distributions can be advantageously used in the formulation and application of some of these additional constraints. For example, in certain embodiments, the inferred cumulative molecular weight distribution for new reactor production is combined with the measured molecular weight distribution of available off-grade resin to infer the molecular weight distribution of the blended resin. This procedure advantageously allows for the reduction or elimination in the presence of gels in the blended product.

One skilled in the art will appreciate that these principles can be applied to a variety of polymerization processes and methods for making blends. The methods described herein are applicable to any system in which resins of different distributions are mixed to form a blend. Such methods include, but are not limited to, post-reactor blending of multi-modal or unimodal resins, multi-reactor systems in series or parallel, and incorporation of small amounts of off-grade product while maintaining acceptable properties in the composition. The methods described herein can also be applied to processes for manufacturing unimodal resins as well. The methods described herein can be applied to batch processes as well as continuous processes by compensating for the fact that product is not withdrawn until the completion of the reaction or batch. The instantaneous properties of the intermediate polymer constantly evolve during the reaction; polymer property control comprises manipulating the process variables during a batch so that the properties of the final product match the target for the batch. Some control strategies use pre-computed trajectories for the manipulation of process variables, such as feed rate, and online control schemes known in the art, particularly those described in Echevarria, A. et al., “Molecular Weight Distribution Control in Emulsion Polymerization”, AIChE J., 44, 1667-1679 (1998) and Ellis, M., et al., “On-line Molecular Weight Distribution Estimation and Control in Batch Polymerization”, AIChE J., 40, 445-462 (1994), the disclosures of which are incorporated herein in their entirety.

### EXAMPLES

The following examples are given to illustrate various embodiments of the invention. They do not intend to limit the invention as otherwise described and claimed herein. All numerical values are approximate. When a numerical range is given, it should be understood that embodiments outside the range are still within the scope of the invention unless otherwise indicated.

### Example 1

Data obtained from simulated polymerization reactors using a mixed-catalyst system for the production of high-density high molecular weight bimodal polyethylene were used to estimate the distribution of molecular weights at an intermediate stage of the polymerization process. Simple reaction and molecular weight distribution models were formulated based on the factors and process parameters discussed above that relate the instantaneous molecular weight distribution of the high and low molecular weight resin components to catalyst and activity modifier feed rates, and reactor conditions. The process data included catalyst and activity modifier feed rates, reaction pressure, temperature, gas compositions, monomer and comonomer feed rates, and calculated reactor production rate. Product samples were withdrawn periodically and the molecular weight distribution of the resin determined by GPC. Additional product properties measured included resin density, I₂ and I₂₁.

Reaction model parameters were fit to the process and molecular weight distribution data using a ‘least squares’ procedure. The distributions were fit to the following formula:

gᵢ^{L}(x,t)=(x−A)*((B/H(t))*e^{CIT(t)}+D)²*exp(−((x−A)*((B/H(t)))*e^{CIT(t)}+D))

where H is the hydrogen concentration at time t and T is the temperature of the reactor. The constants A, B, C, and D are determined from the fit of the reaction data to this general equation where x≧0.60. From the fit of the data, the instantaneous distribution, g, of molecular weights, x, of the low molecular weight component in the polymer composition is given by:

gᵢ^{L}(x,t)=(x−0.10)*((1.2/H(t))*e^{-369/T(t)}+20.1)²* exp(−((x−0.10)*((1.2/H(t)))*e^{-369/T(t)}+20.1))

And where x<0.6, gᵢ^{L}(x,t)=0.

In an analogous manner, the distribution of the high molecular weight component is modeled. Where x>1.2 the instantaneous distribution of molecular weights for the high molecular weight component obtained by fitting the data is given by the equation:

gᵢ^{H}(x,t)=(x−0.21)*((1.0/H(t))*e^{-321/T(t)}+10.2) ²*exp(−((x−0.21)*((1.0/H(t))*e^{-321/T(t)}+10.2)

and where x<1.2, gᵢ^{H}(x,t)=0.

The reaction and molecular weight distribution models were used in subsequent runs to estimate at a pre-determined frequency of once per 5 minutes, the molecular weight distribution of bimodal resin being produced instantaneously in the reactor. To do so the temperature and hydrogen concentration in the reactor are determined. Then the instantaneous distribution is calculated according to the above model. A split is also calculated using the split model discussed earlier. Each time the instantaneous molecular weight distribution is determined, the cumulative or bed-average molecular weight distribution of the resin in the reactor is also updated using according to the following equation:

gᵢ^{M}(x,t)=S(t)·gᵢ^{LMW}(x,t)+(1−S(t))·gᵢ^{HMW}.

$${g}_{C}^{M} ( x , t ) = PR ( t ) \cdot {g}_{i}^{M} ( x , t ) + ( 1 - \frac{PR ( t ) \cdot Δ}{W ( t )} ) \cdot {g}_{C}^{M} ( x , t - Δ )$$

where g_{C}^{M} is the cumulative distribution of the molecular weight, PR is the instantaneous total mass rate of polymer production, gᵢ^{M} is the instantaneous distribution, W is the mass of the polymer bed in the reactor, g_{C}^{M}(x,t−Δ) indicates the cumulative distribution from the previous iteration.

The model may be further corrected periodically by applying a correction factor, U(t), based on analytical measurements.

g_{C,CORR}^{M}(x,t)=g_{C}^{M}(x,t)+U(x,t)

U is defined as

U(x,t)=g_{C}^{Measured}(x,tₛₐₘₚₗₑ)−g_{C,CORR}^{M}(x,t_{SAMPLE})

where g_{C}^{Measured}(x,t_{SAMPLE}) is the distribution measured from the lab at sample taken at time t_{SAMPLE} and g_{C,CORR}^{M}(x,t_{SAMPLE}) is the corrected distribution calculated at time t_{SAMPLE}

At each time interval, the updated instantaneous and cumulative molecular weight distributions are compared with the target or reference molecular weight distribution for the desired product. A quantitative measure of distance, for example, a root-mean-square distance, is used to detenrnine how closely the molecular weight distribution of the resin being produced matches the reference distribution. In some embodiments, the distribution is updated with data from an analytical method such as TREF.

When the distance between the instantaneous molecular weight distribution and the reference distribution exceeds a pre-determined threshold, control action is initiated to minimize the distance. For example, one approach for control action may be to select a target split, S^{Target}(t), that would minimize the least square fit of the instantaneous distribution to the target cumulative distribution. The objective function to minimize could be defined as

J=|g_{C}^{Target}(x,t)−U(x,t)−(S^{Target}(t)*gᵢ^{L}(x,t)+(1−S^{Target}(t))*gᵢ^{H}(x,t))|²

The resulting split to minimize this objective using least squares (dJ/ds=0) can then be explicitly determined

$${S}^{Target} = \frac{{\sum }_{x = 1}^{n} ( {g}_{C}^{Target} ( x , t ) - {g}_{i}^{H} ( x , t ) - U ( t ) ) * ( {g}_{i}^{L} ( x , t ) - {g}_{i}^{H} ( x , t ) ) )}{{\sum }_{x = 1}^{n} {( {g}_{i}^{L} ( x , t ) - {g}_{i}^{H} ( x , t ) )}^{2}}$$

Application of the procedure described above is illustrated below. After several hours of initial operation had elapsed and steady state conditions were reached, the procedure above was started using the process and molecular weight distribution models previously developed obtained from the data measured above.

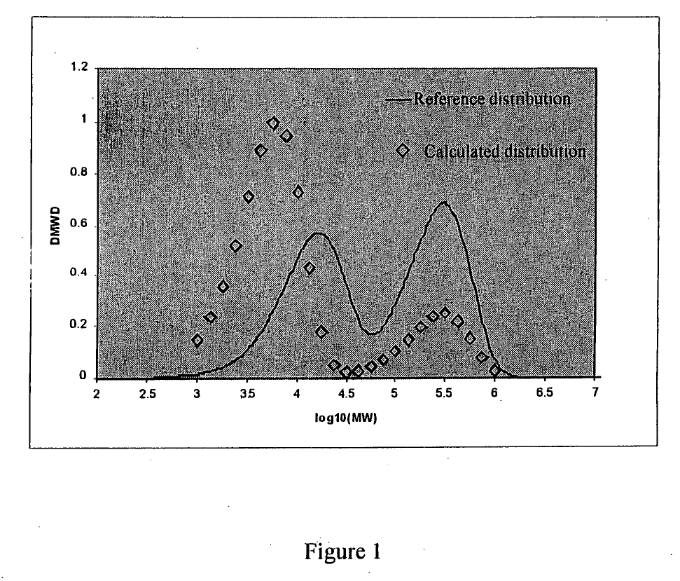

As shown in FIG. 1, a reference distribution of a desired product was compared with the model-based instantaneous distribution shown in discrete form. As FIG. 1 shows, the molecular weight of the low molecular weight component is lower than that of the reference distribution and there is too little high molecular weight component.

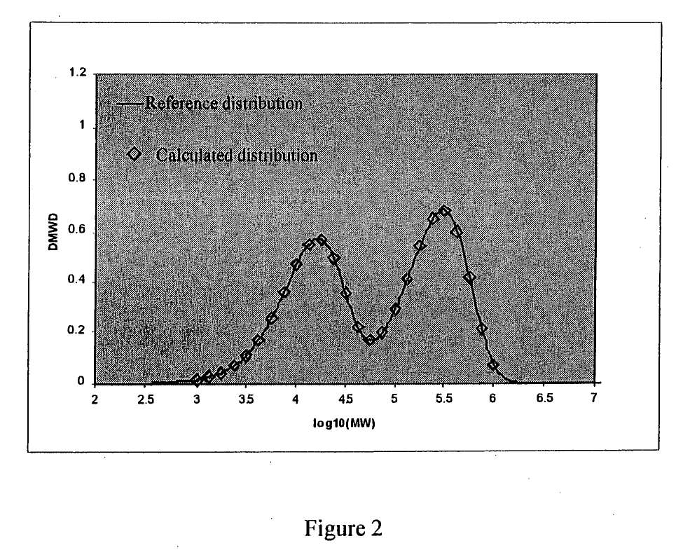

The distance between the two distributions was computed and found to exceed the pre-determined threshold for acceptable product performance. To adjust for the difference between the reference distribution and the modeled distribution, the feed rate of a catalyst activity modifier was required to increase the proportion of the high molecular weight resin component in the product, and that a reduction in the gas-phase H₂/C₂ ratio was needed to raise the molecular weight of the low molecular weight component. The required process adjustments were computed using the instantaneous distribution model and applied. The adjustments applied above produced the new distribution shown in FIG. 2. As FIG. 2 indicates, the model distribution very closes matches the reference distribution.

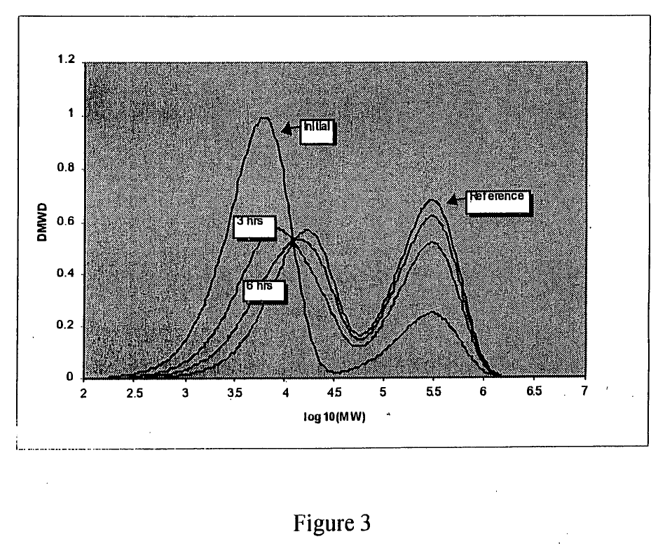

FIG. 3 illustrates the change in the cumulative or bed-average molecular weight distribution as a function of time in response to changes in process parameters deduced from the estimated distribution.

Any model that effectively estimates the distribution of a polymer composition under the reaction conditions may be used. Relevant process data is dictated by the choice of the model used. Rheological methods can usefully be used to characterize molecular weight distributions in place of GPC. While in this example, the parameters of the process were fit to the model by a least squares method, any parameter fitting model may be used. Likewise, any method may be used to determine if control action is necessary because the estimated distribution is outside tolerances of the references distribution.

While the invention has been described with a limited number of embodiments, these specific embodiments are not intended to limit the scope of the invention as otherwise described and claimed herein. Moreover, variations and modifications therefrom exist. It should be recognized that the process described herein may be used to make polymers which incorporate one or more additional comonomers. The incorporation of additional comonomers may result in beneficial properties which are not available to homopolymers or copolymers and parameters for modeling instantaneous and cumulative distributions should be adjusted to account such comonomers. While the processes are described as comprising one or more steps, it should be understood that these steps may be practiced in any order or sequence unless otherwise indicated. These steps may be combined or separated. Finally, any number disclosed herein should be construed to mean approximate, regardless of whether the word “about” or “approximate” is used in describing the number. The appended claims intend to cover all such variations and modifications as falling within the scope of the invention.

What is claimed is:

1. A method of manufacturing a polymer composition, comprising:
(a) initiating a polymerization reaction at an initial set of polymerization parameters;
(b) determining a distribution of the at least one property of an intermediate polymer composition;
(c) adjusting the initial set of polymerization parameters based on the distribution of the at least one property to obtain a desired distribution of the at least one property in the polymer composition.

2. The method of claim 1 further including comparing the distribution to a reference distribution.

3. The method of claim 2, further including minimizing the difference between the distribution and the reference distribution.

4. The method of claim 3 where in minimizing is accomplished by a least squares method.

5. The method of claim 1, wherein the polymer composition is a bimodal polymer composition.

6. The method of claim 1, wherein the polymer composition is an ethylene or propylene homopolymer or alpha-olefin copolymer composition.

7. The method of claim 1, wherein determining a distribution includes determining a cumulative distribution.

8. The method of claim 1, wherein determining a distribution includes determining at least one instantaneous distribution.

9. The method of claim 1, wherein the distribution is a molecular weight distribution.

10. The method of claim 1, wherein determining a distribution includes online estimating a cumulative distribution from the polymerization parameters.

11. The method of claim 1, wherein determining the distribution includes updating a distribution model based on one or more scalar properties of the intermediate polymer composition.

12. The method of claim 11, wherein the scalar properties include melt index, flow index, melt flow ratio, density, or other Theological property.

13. The method of claim 1, wherein the adjusting a polymerization reaction parameter includes adding a catalyst activity modifier.

14. The method of claim 1, wherein adjusting a polymerization reaction parameter includes adding a chain transfer agent.

15. The method of claim 1, wherein initiating the polymerization reaction includes providing a multimodal catalyst system or two separate monomodal catalysts.

16. The method of claim 15, wherein the multimodal catalyst system is a bimodal catalyst system that includes a Ziegler-Natta catalyst.

17. The method of claim 1, wherein the multimodal catalyst system is a bimodal catalyst system that includes at least one Ziegler-Natta catalyst and at least one metallocene catalyst.

18. The method of claim 1, wherein the multimodal catalyst system is a bimodal catalyst system that includes a low molecular weight metallocene catalyst and a high molecular weight catalyst.

19. The method of claim 1, wherein the multimodal catalyst system is a bimodal catalyst system that includes a dual site catalyst system.

20. The method of claim 1, wherein the method is a series or parallel multi-reactor process.

21. The method of claim 1, wherein the discrete points or regions of the cumulative distribution are compared to a reference distribution.

22. The method of claim 1, further including determining a scalar property and wherein adjusting the distribution includes adjusting the scalar property.

23. The method of claim 22, wherein the scalar property is selected from the group consisting of a melt index, a flow index, a melt flow ratio, density, a split, and any rheological property.

24. A method of controlling the polymodal split of a polymerization process, comprising;
(a) conducting said polymerization process in the presence of at least one polyselective catalyst composition;
(b) determining at least one process conditions;
(c) estimating the polymodal split from the process conditions;
(d) adjusting the process conditions to obtain a desired polymodal split.

25. The method of claim 24, wherein the process conditions include catalyst feedrates and the concentration of catalyst promoters or catalyst retarding agents.

26. A method of manufacturing a polymer composition, comprising:
(a) determining a distribution of the at least one property of an intermediate polymer composition;
(b) determining a target distribution of the polymer composition;
(c) adding a polymer component to the intermediate polymer composition, wherein the amount of the polymer component is determined by minimizing the difference between the distribution of the at least one property of the intermediate polymer composition and the target distribution with in a desired range of the at least one property of the polymer composition.

27. A method of manufacturing a polymer composition, comprising:
(a) initiating a polymerization reaction at an initial set of polymerization parameters;
(b) determining a polymer split from an instantaneous distribution of an intermediate polymer composition;
(c) adjusting the initial set of polymerization parameters based on the polymer split to obtain a desired split in the polymer composition.
